(19) United States
(12) Patent Application Publication
(10) Pub. No.: US 2007/0117736 A1
(43) Pub. Date: May 24, 2007

(54) Sprayable high viscosity thixotropic surface cleaners

(76) Inventors: David Lee Figger, Hudson, KS (US); Lewis Lynn Gray, Great Bend, KS (US)

Correspondence Address: Howard M. Ellis;SIMPSON & SIMPSON, PLLC, 5555 Main Street, Williamsville, NY, 14221, US

(21) Appl. No.: 11/285,343

(22) Filed: Nov. 22, 2005

(51) Int. Cl. C11D 17/08

(52) U.S. Cl. 510/421; 510/426

(57) ABSTRACT

A family of sprayable, high viscosity thixotropic surface cleaners which include (i) a thickening agent present in a sufficient amount to impart a viscosity of at least 6,000 cP at standard temperature and pressure when the cleaners are in a rest state; (ii) an aqueous solvent system including water and at least one miscible organic solvent; (iii) a sufficient amount of a thickening agent compatible surfactant; and (iv) sufficient base to provide a pH range to the cleaners ranging from about 5 to about 10. The family of surface cleaners become finely divided fluids when dispensed under high flow or high shear conditions from a sprayer and undergo transformation to semisolid states after dispensing.

### TECHNICAL FIELD

The present invention relates generally to sprayable, high viscosity thixotropic surface cleaning compositions which retain non-dripping or running characteristics, as well as important volatile cleaning ingredients while avoiding overspray, surprisingly when dispensed from a sprayer as a finely divided fluid under high flow or shear conditions.

### BACKGROUND OF THE INVENTION

Sprayable cleaning compositions, such as glass cleaners, all-purpose cleaners, polishing cleaners, and so on, have experienced wide acceptance by the purchasing public. However, many of the commercially available sprayable household cleaning compositions have a relatively low viscosity, and consequently, have a tendency to overspray and drip from the point of contact or run off the surface to which they are applied, whether the surfaces are vertical walls or windows, or from horizontal ceiling surfaces, for example. Movement of the liquid on or from the substrate being cleaned is not unexpected in view of the low viscosity ranges of many of such liquids. This run-off leads to cleaning inefficiencies and waste of product, since non-targeted areas not requiring the application of such solutions are often treated, nevertheless.

Sprayable foaming compositions, while offering some level of improvement, also have a tendency to run and sag rapidly. Foams can also perform less efficiently and less effectively because of deficiencies in surface contact.

Some more recent improvements in sprayable cleaning compositions have been disclosed by Faris in U.S. Pat. Nos. 5,705,470 and 5,977,050. This patentee discloses sprayable cleaning gel compositions as allegedly having viscosity levels ranging from over 900 centipoises (cP) to about 5,500 cP at standard temperature and pressure (25 degrees Centigrade and 1 atmosphere of pressure) characterized as providing improved clinging, and thus dwelling longer on surfaces to be cleaned than prior compositions. In addition, Faris also claims improved surface contact with his compositions during cleaning. The cleaning gel compositions of Faris are said to be relatively viscous, substantially homogeneous, and free of suspended encapsulated particles.

However, Faris was only able to achieve an upper end viscosity with his compositions of a relatively low 5,550 cP using recommended ranges of water soluble polymeric thickeners in amounts up to 10 percent. Notwithstanding this relatively low viscosity, Faris observed the spray was on the verge of generating globs of gel rather than spraying finely.

The inventors herein also observed at viscosity levels of sprayable gels in the range taught by others in the field, such as Faris, premature evaporation of water and volatile organic solvents considered important to cleaner performance occurs.

Accordingly, there is a need for improved sprayable thixotropic surface cleaners of substantially higher viscosity when in a resting state which become uniform, highly divided dispersed liquids when dispensed under high flow or shear conditions from a sprayer, and subsequently undergo rapid transformation back to a semisolid state promptly after dispensing. Additionally, there is a further need for improved sprayable thixotropic surface cleaners which cling to surfaces with virtually no drip or run-off, and are also capable of serving as vehicles for delivering microencapsulated and/or particulate materials while retaining important volatile ingredients.

### SUMMARY OF THE INVENTION

It is therefore a principal object of the invention to provide a novel class of sprayable, high viscosity thixotropic compositions, that are capable of being readily dispensed as uniform dispersions from a conventional finger pump or trigger type hand sprayer, for example. The thixotropic compositions are usually in the form of high viscosity semisolid gels, or other types of dispersions prior to dispensing as a spray from a sprayer equipped container, such as a pressurized aerosol type container or finger operated pump-container, typically a plunger or trigger operated sprayer pump. The sprayable, high viscosity thixotropic compositions of the invention are also especially useful as vehicles for various cleaning agents, e.g., volatile organic solvents, and particulates including micro-encapsulated materials for cleaning and/or polishing hard surfaces, such as glass and metallic substrates, to name but a few.

The high viscosity thixotropic compositions of the invention, when dispensed and applied in the format of spray under conditions of high flow and/or shear from containers of the type previously discussed to hard substrates, for example, the compositions become uniformly dispersed, and rapidly revert back to a semisolid state after dispensing, with no or virtually no run-off or dripping occurring from the treated surface.

It is therefore a further principal object of the invention to provide a family of improved surface cleaners comprising (i) a thickening agent present in a sufficient amount to impart a viscosity of at least 6,000 cP at standard temperature and pressure when the cleaner is in a resting state; (ii) an aqueous solvent system comprising water and at least one miscible organic solvent; (iii) a thickening agent compatible surfactant; and, (iv) sufficient base to provide a pH ranging from about 5 to about 10. The high viscosity thixotropic surface cleaners become finely divided fluids when dispensed under high flow or high shear conditions, such as from a hand sprayer and undergo transformation to a semisolid state after dispensing.

These inventors discovered that certain additives, such as “dispersants”, taught by the Faris patents supra., promote homogeneous distribution of the mixture components and to break-up and disperse soils in sprayable cleaning gel compositions, can have a depressing effect on the viscosity level that would otherwise be expected in using thickening agents. Faris discloses cleaning gel compositions with viscosities only in a range from about 900 cP to about 5,550 cP. Preferred embodiments of dispersants recommended by Faris include the polycarboxylates, e.g., carboxylic acid olefin copolymers and carboxylic acid-vinyl ether copolymers available from BASF under the trademark “SOKOLON”, in particular “SOKOLON CP-9”. Other dispersant additives suggested by Faris are the so called acrylic detergent polymers.

Contrary to the teachings of Faris, these inventors found that substantially higher viscosities can be achieved without the introduction of “dispersants” when a thickening agent is present in a sufficient amount to impart a viscosity to the cleaner ranging from about 6,000 cP to about 25,000 cP at standard temperature and pressure when in a resting state, and more specifically, in amounts sufficient to impart viscosities ranging from about 10,000 cP to about 20,000 cP at standard temperature and pressure when in a resting state. Generally, suitable thickening agents are water soluble viscosity producing resins capable of imparting maximum viscosity at minimum loading.

Surprisingly, it was found that omission of dispersants of the type suggested by Faris supra. allows for lower levels of thickening agent to achieve significantly higher viscosities. The higher levels of thickeners taught by Faris of up to 10 percent by-weight are suggested for viscosities of up to 5,550 cP. The omission of viscosity depressing dispersants according to the present invention allows for the introduction of smaller quantities of more costly thickeners in making the cleaning gel compositions of the invention, including amounts ranging from as low as about 0.05 to about 5.0 percent by-weight, and more particularly, from about 0.01 to about 2.0 percent by-weight to form thixotropic gel cleaning compositions with viscosities as high as 25,000 cP, or greater. Advantageously, the lower levels of thickening agent to achieve higher viscosity ranges translates into substantial economic benefit in terms of cost savings.

Thickening agents according to the present invention may include the acrylic type polymers neutralized with sodium or potassium hydroxide or an amine or ammonia compounds. Representative useful thickening agents especially include the polyacrylic acid polymers and carbomers, available under the Carbopol Ultrez Trademark from Noveon, Inc., of Cleveland, Ohio. Representative useful carbomers, include such commercially available products as Acritamer 505E and Acritamer 501E available from the Rita Corp., Woodstock, Ill., which are homopolymers of acrylic acid cross-linked with an allyl ether of pentaerythritol, an allyl ether of sucrose, or an allyl ether of propylene.

The aqueous solvent system of the thixotropic compositions comprises from about 80.0 percent to about 99.0 percent by-weight water, and from about 1.0 percent to about 20.0 percent by-weight miscible organic solvent. Volatile organic solvents in particular greatly enhance cleaning performance on many soils, however they must be maintained on the surface long enough to act on the soils. These inventors found that the higher viscosities disclosed herein reduce the rate of volatilization of these important cleaning adjuvants.

Representative miscible organic solvents may be a member selected from the group consisting of glycol ethers, alcohols and mixtures thereof. Useful alcohols include especially the lower alkyl alcohols, such as methanol, ethanol, propanols, such as isopropanol, butanols, to name but a few.

The thixotropic cleaning compositions of the invention may also include other additives, such as scrubbing additives or gas, e.g., air bubbles, microencapsulated beads, sequestering agents, fragrances, colorants. Representative scrubbing additives include pumice, calcium carbonate, ground marble, perlite, diatomaceous earth, and so on.

While the nature of the compositions of the invention are generally understood, nevertheless without being restricted to any specific theory, these inventors believe the compositions of the invention are dispersions, rather than true solutions, and that dispensing of the thixotropic compositions of the invention under high pressure or high shear forces of a conventional household sprayers, e.g., plunger or trigger type hand sprayers, or aerosol containment, transforms the semisolid thixotropic gel in the container to a sol. That is, the thixotropic composition in the spray container is believed to undergo gel-sol transformation, wherein at least some of the particles of the dispersed phase are of colloidal dimension and become distributed in the liquid phase of the medium. However, after the composition is discharged from the sprayer as a sol, it rapidly reverts back to a semisolid high viscosity state on or before contact with the surface to be cleaned.

Hence, performance of the compositions in reverting back to the higher viscosity semisolid state after discharge from a sprayer under high pressure or high shear force operates to enhance overall performance of the cleaner by more effectively avoiding surface run-offs and dripping, limits unwanted overspray and the occurrence of premature evaporation of important volatile cleaning ingredients.

These and other features and advantages of the invention will become more apparent from a reading of the following detailed description of the invention.

### DETAILED DESCRIPTION OF THE PREFERRED EMBODIMENTS

It is understood that this invention is not limited to the particular methodology, materials and modifications described and as such may, of course, vary. It is also understood that the terminology used herein is for the purpose of describing particular embodiments only, and is not intended to limit the scope of the present invention.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

The novel general purpose hard surface cleaners of the present invention intended for home, institutional and industrial settings are designed with thickening properties to deliver improved performance and appearance qualities that exceed similar commercially available products. The high viscosity surface cleaning compositions with gel properties include all purpose no-drip hard surface cleaners, as well as specifically formulated products, including but not limited to no-drip window cleaning gels, multisurface cleaning gels, no-drip polish gels, and the like.

In one preferred embodiment of the invention, the sprayable, high viscosity thixotropic gels comprise from about 0.1 percent to about 3.0 percent by-weight of a thickener; an aqueous solvent system having from about 80.0 percent to about 99.0 percent by-weight water and at least one miscible organic solvent in an amount from about 1.0 percent to 20.0 percent by-weight; from about 0.01 percent by-weight to about 10.0 percent by-weight of a nonionic or anionic surfactant, or mixtures thereof; and, sufficient base to provide a pH range to the gels ranging from about 5 to about 10. In this preferred embodiment, the sprayable cleaning gels have a viscosity from at least 6,000 cP to about 25,000 cP at standard temperature and pressure. In a further preferred embodiment of the present invention, the sprayable, cleaning gels have a viscosity from about 10,000 cP to about 20,000 cP at standard temperature and pressure.

In yet a further preferred embodiment, the miscible organic solvent is a lower alkyl alcohol. And in a further preferred embodiment, the thickening agent is a polyacrylic acid polymer. Additionally, the cleaning gels may optionally include additional adjuvants such as scrubbing and/or polishing additives, e.g., pumice, calcium carbonate, ground marble, perlite and diatomaceous earth; gas; microencapsulated beads; sequestering agents; fragrances; and, colorants.

### Components of the Sprayable, High Viscosity Thixotropic Gel

The sprayable, high viscosity thixotropic gel of the present invention primarily includes a liquid carrier, at least one solvent and at least one surfactant. These components are described hereinbelow seriatim.

### Liquid Carrier

According to the present invention, the carrier fluid may include water, thickening agent, base solution and mixtures thereof. Typically, so that resultant compositions perform predictably, de-ionized water is used. However, as one of ordinary skill in the art will recognize, any form of purified water may be used, e.g., distillation or reverse osmosis purified water, and such other purified waters are within the scope of the invention as claimed.

The sprayable, high viscosity cleaning gels of the present invention have a preferred viscosity of at least 6,000 cP, and more specifically, a viscosity in a range of about 6,000 cP to about 25,000 cP at standard temperature and pressure. As purified water does not provide such elevated viscosities, a thickening agent is added to the compositions. Although the preferred thickening agent is a polyacrylic acid powder available from Noveon in Cleveland, Ohio, i.e., Carbopol Ultrez 10, other suitable thickening agents exist, e.g., Carbopol Ultrez 20 and Carbopol EZ3 (each are available from Noveon). Additionally, other suitable thickening agents including Acitamer 501E, 505E and 940 are available from Rita Corporation in Woodstock, Ill.

As the thickening agents, in a preferred embodiment, are polymeric molecules, the liquid carrier must include a base solution whereby the polymeric molecules are uncoiled, thus accomplishing gelatinous thickening of the composition. The addition of the base solution raises the pH of the composition to a value from about 5 to about 10. Suitable base solutions include, but are not limited to, ammonium hydroxide, sodium hydroxide, potassium hydroxide, diethanolamine, triethanolamine, monoethanolamine, isopropanolamine and diisopropanolamine.

### Solvents

As the present invention thixotropic gels are intended for use as cleaning solutions, the incorporation of solvents within the composition promotes greater cleaning potential. As described supra, in a preferred embodiment, the “aqueous solvent system” comprises water and at least one miscible organic solvent. Water may be present in an amount ranging from about 80.0 to about 99.0 percent by-weight and the water miscible organic solvent may range from about 1.0 to about 20.0 percent by-weight. For purposes of this invention the expression “miscible organic solvent” or “water miscible organic solvent”, as appearing in the specification and claims, is intended to include alcohols, glycol ethers and mixtures thereof. In addition to the foregoing classes of organic solvents, miscible organic solvents are intended to include higher molecular weight water miscible organic solvents, such as polypropylene glycol. They are not only employed for their solvent characteristics, but also perform as “polishing additives” in the gel cleaning compositions of the invention, such as in no-drip polishing gels, microencapsulated wood cleaner and polishing gels, and so on.

Preferred representative alcohols include, but are not limited to, isopropyl alcohol, ethanol, methanol, tert-butyl alcohol, benzyl alcohol, and so on.

Additionally, glycol ethers are a preferred class of supplemental solvents to help dissolve oil-based materials, regardless of whether those oil-based materials are part of the cleaning composition, e.g., oil-based fragrances, or whether the oil-based material is soil to be cleaned off a surface. Suitable glycol ethers include, but are not limited to, propylene glycol n-propyl ether, dipropylene glycol n-propyl ether, dipropylene glycol n-butyl ether, propylene glycol n-butyl ether, dipropylene glycol methyl ether, tripropylene glycol methyl ether, ethylene glycol n-butyl ether, diethylene glycol n-butyl ether, diethylene glycol methyl ether, ethylene glycol phenyl ether, ethylene glycol n-hexyl ether and diethylene glycol monoethyl ether.

### Surfactants

It has been discovered by the inventors that in order to maintain the viscosity range of the instant invention cleaning compositions, surfactants compatible with the thickening agent should be used. Thus, referring to thickening agent compatible surfactants implies surfactants that do not cause a deleterious effect on composition viscosity, i.e., do not suppress composition viscosity. Contrarily, referring to non-compatible surfactants implies surfactants that have a deleterious effect on composition viscosity, i.e., lowering composition viscosity. Thickening agent compatible surfactants include nonionic and anionic surfactants.

Nonionic surfactants may be broadly defined as compounds produced by condensation of alkylene oxide groups with an organic hydrophobic material which may be aliphatic or alkyl aromatic in nature. Examples of suitable nonionic surfactants include, but are not limited to polyoxyethylene or polyoxy-propylene condensates of alkyl phenols, and polyoxyethylene or polyoxypropylene condensates of aliphatic alcohols.

Polyoxyethylene or polyoxypropylene condensates of alkyl phenols include the condensation products of alkyl phenols having an alkyl group containing from about 6 to about 12 carbon atoms in either a straight chain or branched configuration with ethylene and/or propylene oxide, wherein the ethylene and/or propylene oxide is present as 5 to 25 moles of ethylene and/or propylene oxide per mole of alkyl phenol. Examples of compounds of this type include nonyl phenol condensed with about 9.5 moles of ethylene oxide per mole of phenol and octyl phenol reacted with about 10 moles of ethylene oxide per mole of phenol. Commercially available nonionic surfactants of this type include T-Det-N-9.5 from Harcros Chemical of Kansas City, Kans., and Surfonic OP-100 marketed by Huntsman Corporation of Port Houston, Tex.

Polyoxyethylene or polyoxypropylene condensates of aliphatic alcohols, whether linear or branched chained, and saturated or unsaturated, contain from about 6 to about 24 carbon atoms and incorporate from about 5 to about 50 ethylene oxide and/or propylene oxide units. Suitable alcohols include “coconut” fatty alcohol, “tallow” fatty alcohol, lauryl alcohol, myristyl alcohol and oleyl alcohol. A preferred linear alcohol ethoxylate is Tomadol 1-7, a C11 with 7 moles of ethylene oxide, commercially available from Tomah Products of Milton, Wis.

Anionic surfactants, also known as synthetic detergents, may be broadly described as surface active agents with one or more negatively charged functional groups. An important class of anionic compounds is water-soluble salts, particularly alkali metal salts of organic sulfur reaction products having in their molecular structure an alkyl radical containing from 8 to 22 carbon atoms and a radical selected from the group consisting of sulfonic acid and sulfuric acid ester radicals. Representative examples of organic sulfur-based anionic surfactants include, but are not limited to, salts of C10-C14 alkylbenzene sulfonates, C10-C22 alkene sulfonates, C10-C22 alkyl ether sulfonates, C10-C22 alkyl sulfates, C4-C10 dialkyl sulfosuccinates, C10-C22 acyl methionates, alkyl diphenyloxide sulfonates, alkyl naphthalene sulfonates and 2-acetamido hexadecane sulfonates. Also included in the group of anionic surfactants are nonionic alkoxylates having a sodium alkylene carboxylate moiety linked to a terminal hydroxyl group of nonionic alkoxylate through an ether bond. Counter-ions to the salts of all the foregoing compositions may be alkali metal, alkaline earth metal, ammonium, alkanolammonium and soluble alkylbenzene sulfonate salts of organic sulfur-reaction products. These inventors have found that linear straight-chain alkylbenzene sulfonates in which the average number of carbon atoms in the alkyl group is from about 11 to about 13 (C11-C13 LAS) are of particular value. Examples of yet other anionic surfactants include sodium alkyl glyceryl ether sulfonates and water soluble salts of esters of alpha-sulfonated fatty acids.

Through discovery of thickener compatible surfactants, the inventors of the instant invention have also identified non-compatible surfactants. Non-compatible surfactants include, but are not limited to, polyvalent electrolyte polymers and cationic surfactants.

Polyvalent electrolyte polymers include those polyelectrolyte polymer dispersants whose function is to disperse solid particle materials or suspend such materials to prevent agglomeration. These materials have been found to interfere with proper viscosity development of the instant invention by substantially lowering the resting state viscosity to non-optimum levels of less than 6,000 cP. These polymers are typically polycarboxylates and include carboxylic acid-olefin polymers and polyacrylic polymers. Examples of this type of dispersant, ones that have deleterious effects on viscosity and rheological characteristics, include Sokalan CP-9 by BASF Specialty Products of Parsippany, N.J., and the hydrolyzed GANTREZ S polycarboxylic acid resins from International Specialty Products of Wayne, N.J.

Cationic surfactants can broadly be described as surface active agents with a positive charge, including quaternary ammonium salts. These materials were discovered to be less suitable for use with a preferred embodiment of the instant invention, i.e., an embodiment including the preferred polyacrylic acid thickener. The result of using these materials in combination was found to be a destruction of the gel matrix, and thus, can decrease the composition viscosity. Examples of these types of surfactants include n-alkyl dimethyl benzyl/dioctyl, didecyl, octyl decyl dimethyl, methyl benzyl, dimethyl ethylbenzyl ammonium chloride.

### Heterogeneous Additives

The gel cleaning compositions of the invention may also contain heterogeneous materials, including air and other gaseous phase additives; solid materials, such as abrasives to assist in scrubbing, including pumice, calcium carbonate or ground marble, Perlite and diatomaceous earth; active liquid phase ingredients that are not miscible with the homeogeneous aqueous phase of the composition, and active liquid or dry materials which can be entrapped into a suspended solid phase, such as microencapsulated beads and particulate materials.

Microencapsulated beads are composed of an outer hard or semi-hard shell and a liquid inner content. These materials provide means for delivering an active ingredient to a surface in a finite delivery vehicle. They are made generally through one of a group of process options. These include “coacervation” wherein core-shell beads are from about 25 to 2000 microns and are ideal for encapsulating oils and other hydrophobic compounds. Wall materials are usually gelatin, polyvinyl alcohol, methyl cellulose, or polyvinyl pyrrolidone. Durable wall formed of gelatin with acacia modification are one of the preferred embodiments using complex coacervation. For liquids, the payload or fill, can reach 90% and is generally a water insoluble material.

A further type of microencapsulate is the alginate gel which exhibits a solid alginate phase that is not just an outer shell, but a discontinuous solid matrix that has liquid imbedded therein. Further alternatives are based on polyoxymethylene urea as the shell material, commonly called PMU type. It is formed through a reactive emulsion encapsulation technique which produces durable beads generally of 10-120 microns with a tough polymer shell and oil/hydrophobic liquid core. It can also be used for encapsulation of fragrances, and oils. Any hydrophobic liquid that is essentially not water soluble and of low viscosity can be used. The beads are a core shell microcapsules with up to 90% liquid fill.

The following examples are intended to be illustrative, and thus are not restrictive.

### EXAMPLE I

### Window Cleaning Gel

A sprayable, high viscosity thixotropic gel suitable as a no drip window cleaner was made at substantially standard temperature and pressure in a mixing kettle using the materials listed in Table 1, according to the following procedure:
1. Charge water to mix kettle and add Carbopol with good mixing until a fine dispersion is attained (Table 1, Material group 1);
2. Add materials of Table 1, Material group 2, in the order described hereinbelow, with good mixing;
3. Pre-dissolve dye in water (Table 1, Material group 3) then add to batch; and,

4. Carefully add ammonia (Table 1, Material group 4) to batch and mix until clear and homogeneous.

TABLE 1

| Material Group | Component | Amount (lbs) |
|---|---|---|
| 1 | Deionized water | 7884.1 |
| | Carbopol Ultrez-10 | 12.4 |
| 2 | Isopropanol | 272.6 |
| | Propylene glycol n-propyl ether | 57.8 |
| | Ammonium laureth sulfate | 8.3 |
| | Fragrance | 8.3 |
| 3 | Deionized water | 8.3 |
| | Dye | 15.0 grams |
| 4 | Aqua Ammonia | 8.3 |
| | Total | 8260.0 |

The materials described in Table 1 are also described in Table 2 according to percent by weight contribution.

TABLE 2

| Component | Component Name | % by weight |
|---|---|---|
| Thickener | Carbopol Ultrez-10 | 0.1500 |
| Water | Deionized water | 95.5496 |
| Solvent | Isopropanol | 3.3000 |
| Solvent | Propylene glycol n-propyl ether | 0.7000 |
| Surfactant | Ammonium laureth sulfate | 0.1000 |
| Fragrance | Fragrance | 0.1000 |
| Base | Aqua ammonia | 0.1000 |
| Dye | Dye | 0.0004 |
| | Total | 100.0000 |

The properties of the sprayable, high viscosity thixotropic gel of Tables 1 and 2 are described in Table 3 hereinbelow.

TABLE 3

| Test | Value | Method |
|---|---|---|
| Appearance | Transparent Gel | Visual |
| Odor | To match standard | |
| pH | 8.5 ± 1.0 | ASTM E70 |
| Viscosity @ 25° C. | 13,000 ± 5,000 cP | ASTM D2983 |
| (Brookfield LVF #3 @ 6 rpm) | | |
| Wt./Gal. | 8.26 ± 0.04 | ASTM D1475 |
| Specific Gravity @ 25° C. | 0.992 ± 0.005 | ASTM D891 |
| Flash Point | 134° F. (Setaflash) | ASTM D3828 |

### EXAMPLE II

### Multi-Surface Cleaning Gel

A sprayable, high viscosity thixotropic gel suitable as a multi-surface cleaner was made at substantially standard temperature and pressure in a mixing kettle using the materials listed in Table 4 below, according to the following procedure:
1. Charge water to mix kettle and add Carbopol with good mixing until a fine dispersion is attained (Table 4, Material group 1);
2. Add materials of Table 4, Material group 2, in the order described hereinbelow, with good mixing;
3. Pre-dissolve dye in water (Table 4, Material group 3) then add to batch; and,

4. Carefully add ammonia (Table 4, Material group 4) to batch and mix until clear and homogeneous.

TABLE 4

| Material Group | Component | Amount (lbs) |
|---|---|---|
| 1 | Deionized water | 7818.9 |
| | Carbopol Ultrez-10 | 10.3 |
| 2 | Isopropanol | 165.0 |
| | Propylene glycol n-propyl ether | 165.0 |
| | Nonylphenol 9.5 E.O. | 57.8 |
| | Fragrance | 16.5 |
| 3 | Deionized water | 8.3 |
| | Dye | 29.9 grams |
| 4 | Aqua Ammonia | 8.3 |
| | Total | 8250.0 |

The materials described in Table 4 are also described in Table 5 according to percent by weight contribution.

TABLE 5

| Component | Component Name | % by weight |
|---|---|---|
| Thickener | Carbopol Ultrez-10 | 0.1250 |
| Water | Deionized water | 94.8742 |
| Solvent | Isopropanol | 2.0000 |
| Solvent | Propylene glycol n-propyl ether | 2.0000 |
| Surfactant | Nonylphenol 9.5 E.O. | 0.7000 |
| Fragrance | Fragrance | 0.2000 |
| Base | Aqua ammonia | 0.1000 |
| Dye | Dye | 0.0008 |
| | Total | 100.0000 |

The properties of the sprayable, high viscosity thixotropic gel of Tables 4 and 5 are described in Table 6 herein-below.

TABLE 6

| Test | Value | Method |
|---|---|---|
| Appearance | Transparent Gel | Visual |
| Odor | To match standard | |
| pH | 8.0 ± 0.5 | ASTM E70 |
| Viscosity @ 25° C. | 10,000 ± 2,500 cP | ASTM D2983 |
| (Brookfield LVF #4 @ 30 rpm) | | |
| Wt./Gal. | 8.25 ± 0.04 | ASTM D1475 |
| Specific Gravity @ 25° C. | 0.991 ± 0.005 | ASTM D891 |
| Flash Point | 142° F. (Setaflash) | ASTM D3828 |

### EXAMPLE III

### No Drip Polish Gel

A sprayable, high viscosity thixotropic gel suitable as a polish gel was made at substantially standard temperature and pressure in a mixing kettle using the materials listed in Table 7, according to the following procedure:
1. Charge water to mix kettle and add Carbopol with good mixing until a fine dispersion is attained (Table 7, Material group 1);
2. Add materials of Table 7, Material group 2, in the order described hereinbelow, with good mixing;
3. Pre-dissolve dye in water (Table 7, Material group 3) then add to batch; and,

4. Carefully add ammonia (Table 7, Material group 4) to batch and mix until clear and homogeneous.

TABLE 7

| Material Group | Component | Amount (lbs) |
|---|---|---|
| 1 | Deionized water | 7493.0 |
| | Carbopol Ultrez-10 | 10.6 |
| 2 | Polypropylene Glycol | 845.0 |
| | Nonylphenol 9.5 E.O. | 59.2 |
| | Dimethylol Dimethylhydantoin | 16.9 |
| | Fragrance | 8.5 |
| 3 | Deionized water | 8.5 |
| | Dye | 30.7 grams |
| 4 | Aqua Ammonia | 8.5 |
| | Total | 8450.0 |

The materials described in Table 7 are also described in Table 8 according to percent by weight contribution.

TABLE 8

| Component | Component Name | % by weight |
|---|---|---|
| Thickener | Carbopol Ultrez-10 | 0.1250 |
| Water | Deionized water | 88.7742 |
| Preservative | Dimethylol Dimethylhydantoin | 0.2000 |
| Polishing* | Polypropylene glycol | 10.0000 |
| Surfactant | Nonylphenol 9.5 E.O. | 0.7000 |
| Fragrance | Fragrance | 0.1000 |
| Base | Aqua ammonia | 0.1000 |
| Dye | Dye | 0.0008 |
| | Total | 100.0000 |
| *Polishing/Solvent Additive—The polypropylene glycol can be described as | | |
| # a propylene oxide adduct of propylene glycol that can be used in the | | |
| # Molecular weight range of 200 to 600 such as Polyglycol P425 from Dow | | |
| # Chemical, Midland, MI 48674. | | |

The properties of the sprayable, high viscosity thixotropic gel of Tables 7 and 8 are described in Table 9 herein-below.

TABLE 9

| Test | Value | Method |
|---|---|---|
| Appearance | Transparent Gel | Visual |
| Odor | To match standard | |
| pH | 8.0 ± 0.5 | ASTM E70 |
| Viscosity @ 25° C. | 10,000 ± 2,500 cP | ASTM D2983 |
| (Brookfield LVF #4 @ 30 rpm) | | |
| Wt./Gal. | 8.45 ± 0.04 | ASTM D1475 |
| Specific Gravity @ 25° C. | 1.015 ± 0.005 | ASTM D891 |
| Flash Point | >200° F. (Setaflash) | ASTM D3828 |

### EXAMPLE IV

### Orange Oil Microcapsule Cleaning Gel

A sprayable, high viscosity thixotropic gel suitable as a orange oil microcapsule cleaning gel was made at substantially standard temperature and pressure in a mixing kettle using the materials listed in Table 10, according to the following procedure:
1. Charge water to mix kettle and add Carbopol with good mixing until a fine dispersion is attained.
2. Add materials in order listed with good mixing.
3. Pre-dissolve dyes in water then add to batch.
4. Carefully add ammonia to batch and mix until clear and homogenous.

5. Slowly add microcapsule slurry to the batch with slow cross sweep agitation. Mix for at least an hour.

TABLE 10

| Material Group | | | |
|---|---|---|---|
| (component) | | Component Name | % BY WT. |
| 1. | (Water) | Deionized water | 94.5242 |
| | (Thickener) | Carbopol Ultrez-10 | 0.1250 |
| 2. | (Solvent) | Isopropanol | 2.0000 |
| | (Solvent) | Propylene glycol n-propyl ether | 2.0000 |
| | (Surfactant) | Nonylphenol 9.5 E.O. | 0.7000 |
| | (Fragrance) | Fragrance | 0.2000 |
| 3. | (Water) | Deionized water | 0.1000 |
| | (Dye) | Dye | 0.0008 |
| 4. | (Base) | Aqua ammonia | 0.1000 |
| 5. | (Special Function) | *microcapsule slurry containing | 0.2500 |
| | | 80-85% orange oil with | |
| | | microcapsule wall consisting of | |
| | | gelatin & gum arabic | |
| | | Total | 100.0000 |
| *Available under the trade name of ISP Captivates HC2371 through | | | |
| # International Specialty Products (ISP) Wayne, NJ | | | |

The properties of the sprayable thixotropic orange oil microcapsule cleaning gel of Table 10 are described in Table 11 herein-below.

TABLE 11

| Test | Value | Method |
|---|---|---|
| Appearance | Transparent Gel | Visual |
| Odor | To match standard | |
| pH | 8.0 ± 0.5 | ASTM E70 |
| Viscosity @ 25° C. | 10,000 ± 2,500 cPs | ASTM D2983 |
| (Brookfield LVF #4 @ 30 rpm) | | |
| Wt./Gal. | 8.25 ± 0.04 | ASTM D1475 |
| Specific Gravity @ 25° C. | 0.991 ± 0.005 | ASTM D891 |
| Flash Point | 142° F. (Setaflash) | ASTM D3828 |

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

We claim:

1. A sprayable, high viscosity thixotropic surface cleaner, which comprises (i) a thickening agent present in a sufficient amount to impart a viscosity of at least 6,000 cP at 25 degrees Centigrade when said cleaner is in a resting state; (ii) an aqueous solvent system comprising water and at least one miscible organic solvent; (iii) a sufficient amount of a thickening agent compatible surfactant; and, (iv) sufficient base to provide a pH range to said thixotropic surface cleaner ranging from about 5 to about 10, said high viscosity thixotropic surface cleaner becoming a finely divided fluid when dispensed under high flow or high shear conditions from a sprayer and undergoes transformation to a semisolid state after dispensing.

2. The sprayable, high viscosity thixotropic surface cleaner according to claim 1, wherein said thixotropic surface cleaner is a gel when in a resting state, and said thickening agent compatible surfactant is a member selected from the group consisting of a nonionic surfactant and a anionic surfactant.

3. The sprayable, high viscosity thixotropic surface cleaner according to claim 2, wherein said gel undergoes transformation to a sol when dispensed under high flow or mechanical shear forces from said sprayer.

4. The sprayable, high viscosity thixotropic surface cleaner according to claim 1, wherein said semisolid state after dispensing is sufficient to maintain the properties of said cleaner to at least one member selected from the group consisting of (i) substantially free of dripping or running when applied to a surface, (ii) limited overspraying and (iii) limited premature evaporation of said aqueous solvent system from said surface.

5. The sprayable, high viscosity thixotropic surface cleaner according to claim 1, wherein said thickening agent is present in a sufficient amount to impart a viscosity to said cleaner ranging from about 6,000 cP to about 25,000 cP at 25 degrees Centigrade when in a resting state.

6. The sprayable, high viscosity thixotropic surface cleaner according to claim 1, wherein said thickening agent is present in a sufficient amount to impart a viscosity ranging from about 10,000 cP to about 20,000 cP at 25 degrees Centigrade when in a resting state.

7. The sprayable, high viscosity thixotropic surface cleaner according to claim 1, wherein said aqueous solvent system comprises from about 80.0 percent to about 99.0 percent by-weight water, and from about 1.0 percent to about 20.0 percent by-weight miscible organic solvent.

8. The sprayable, high viscosity thixotropic surface cleaner according to claim 7, wherein the miscible organic solvent is a member selected from the group consisting of a glycol ether, alcohol and mixtures thereof.

9. The sprayable, high viscosity thixotropic surface cleaner according to claim 8, wherein the alcohol is a lower alkyl alcohol.

10. The sprayable, high viscosity thixotropic surface cleaner according to claim 1, wherein the thickening agent is a water soluble viscosity producing resin suitable for imparting maximum viscosity at minimum loading.

11. The sprayable, high viscosity thixotropic surface cleaner according to claim 10, wherein the thickening agent is a member selected from the group consisting of polyacrylic acid polymers and carbomers.

12. The sprayable, high viscosity thixotropic surface cleaner according to claim 1, comprising at least one member selected from the group consisting of scrubbing additives, a gas, microencapsulated beads, sequestering agent, fragrance and colorant.

13. The sprayable, high viscosity thixotropic surface cleaner according to claim 12, wherein the scrubbing additive is a member selected from the group consisting of pumice, calcium carbonate, ground marble, perlite and diatomaceous earth.

14. The sprayable, high viscosity thixotropic surface cleaner according to claim 1, which is a member selected from the group consisting of a window cleaner gel, a multi-surface cleaning gel and a polishing gel.

15. The sprayable, high viscosity thixotropic surface cleaner according to claim 5, which is a member selected from the group consisting of a window cleaner gel, a multi-surface cleaning gel and a polishing gel.

16. The sprayable, high viscosity thixotropic surface cleaner according to claim 6, which is a member selected from the group consisting of a window cleaner gel, a multi-surface cleaning gel and a polishing gel.

17. The sprayable, high viscosity thixotropic surface cleaner according to claim 12, which is a member selected from the group consisting of a window cleaner gel, a multi-surface cleaning gel and a polishing gel.

18. A sprayable, high viscosity cleaner gel, which comprises (i) from about 0.1 to about 3.0 percent by-weight of a thickener; (ii) an aqueous solvent system comprising from about 80.0 to 99.0 percent by-weight water and at least one miscible organic solvent in an amount from about 1.0 to about 20.0 percent by-weight; (iii) from about 0.1 to about 10.0 percent by-weight of a nonionic surfactant or anionic surfactant; and, (iv) sufficient base to provide a pH range to said cleaner gel ranging from about 5 to about 10, said high viscosity thixotropic cleaner becoming a finely divided fluid when dispensed under high flow or high shear conditions from a sprayer and undergoes transformation to a semisolid state after dispensing.

19. The sprayable, high viscosity cleaner gel according to claim 18, which is a member selected from the group consisting of a window cleaner gel, a multi-surface cleaning gel and a polish gel.
